(19) United States
(12) Patent Application Publication
(10) Pub. No.: US 2007/0168333 A1
(43) Pub. Date: Jul. 19, 2007

(54) Data processing method

(76) Inventor: Hung-Chih Yu, Hsin-Tien (TW)

Correspondence Address: J.C. Patents, Inc., Suite 250, 4 Venture, Irvine, CA, 92618, US

(21) Appl. No.: 11/326,777

(22) Filed: Jan. 5, 2006

(51) Int. Cl. G06F 17/30

(52) U.S. Cl. 707/3

(57) ABSTRACT

A data processing method for an electronic device is provided. Tree-like data groups have been stored in the electronic device. Each first level data group of the tree data groups has a data group name, and each data group has a plurality of character strings. The data processing method includes the following steps. First, a key word is received, and the first word of the first level data group name of the tree data groups is compared with the key word to display the first level data group name conforming to the key word. Then, a select order is received, and the character string of the first level data group or the second level data group corresponding to the select order is displayed.

### BACKGROUND OF THE INVENTION

1. Field of the Invention

The present invention relates to a data processing method, and more particularly, to a data processing method in which the user can easily input the data into the electronic device and quickly query the data stored in the electronic device.

2. Description of the Related Art

Recently, the information technology has been greatly improved, various information products such as mobile phones, personal computers and personal digital assistants (PDA) are commonly used in our daily life. With the help of such information products, the requirements in our daily life in various aspects including food, clothes, accommodation, transportation, education and entertainment can be fully fulfilled; thus, people heavily rely on the information products, and the information products have become dispensable in our daily life now. Along with the continuous development and improvement on the electronic technique and manufacturing process, new information products having more humane and user-friendly functions are continuously launched by vendors. Since the pace of the modem life is fast, more effective communication method is in demand. Accordingly, the conventional telephone set is replaced with the mobile phone. With its advantages of great mobility and convenience, the mobile phone has become the most convenient and effective communication tool for users to communicate with each other.

Currently, while inputting the address data to the mobile phone, the mobile phone will compare the address data stored in the database and display the related information, which facilitates the user in inputting and selecting the address data. Even though, since there may be too many matched data, and the small screen of the mobile phone cannot display all matched data in one page, thus multiple pages are required in searching the desired data. Accordingly, the number of the key presses required by the user to find the matched data is not reduced, and it may take more time to browse and find the desired data.

FIG. 1 schematically shows a screen while inputting the address into the conventional mobile phone. Referring to FIG. 1, when the user desires to input the four characters [symbol] into the mobile phone, after inputting the first character [symbol] several records of data having the first character of [symbol] are displayed on the screen, and the [symbol] matching with the exact characters that the user desires to key in is displayed at the bottom of the data. Accordingly, if the road name that the user desires to key in is not displayed at the top of the data records, it may be more convenient for the user to directly input the address rather than select it from the full candidate list.

### SUMMARY OF THE INVENTION

Therefore, it is an object of the present invention to provide a data processing method in which the user can easily input the data into the electronic device and quickly query the data stored in the electronic device.

In order to achieve the object mentioned above and others, a data processing method for an electronic device is provided; tree-like data groups have been stored in the electronic device. Wherein, each first level data group of the tree data groups has a data group name, and each data group has a plurality of character strings. The data processing method includes the following steps. First, a first key word is received, and the first word of the first level data group name of the tree data groups is compared with the first key word to display the first level data group name conforming to the first key word. Then, a first select order is received, and the character string of the first level data group or the second level data group corresponding to the first select order is displayed.

In accordance with an embodiment of the present invention, after displaying the character string of the data group corresponding to the first select order, the data processing method further comprises the following steps. First, a second select order is received, and a character string corresponding to the second select order is displayed. Then, a second key word is received, and the second key word is added into the character string.

In accordance with an embodiment of the present invention, after displaying the character string of the data group corresponding to the first select order, the data processing method further comprises the following steps. First, a second select order is received and a character string corresponding to the second select order is displayed. Then, a second key word is received and one word in the character string is replaced with the second key word.

In accordance with an embodiment of the present invention, the tree data groups may be address tree data groups. In addition, a level of the address tree data groups may be street names, the other level of the address tree data groups may be lane names. Alternatively, another level of the address tree data groups may be alley names.

In accordance with an embodiment of the present invention, the key word may be a character, a number or a symbol.

In summary, in the present invention, the data stored in the electronic device is divided into different groups, thus once the user keys in the key word, the desired data can be quickly obtained by querying the data from the corresponding data group. Moreover, with similar method, the user can quickly input the data character string into the electronic device.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a screen while inputting the address into the conventional mobile phone.

FIG. 2 schematically shows a flowchart illustrating a data processing method according to an embodiment of the present invention.

FIGS. 3A and 3B schematically show the screens while inputting the data.

FIG. 4 schematically shows a flowchart illustrating a data processing method according to another embodiment of the present invention.

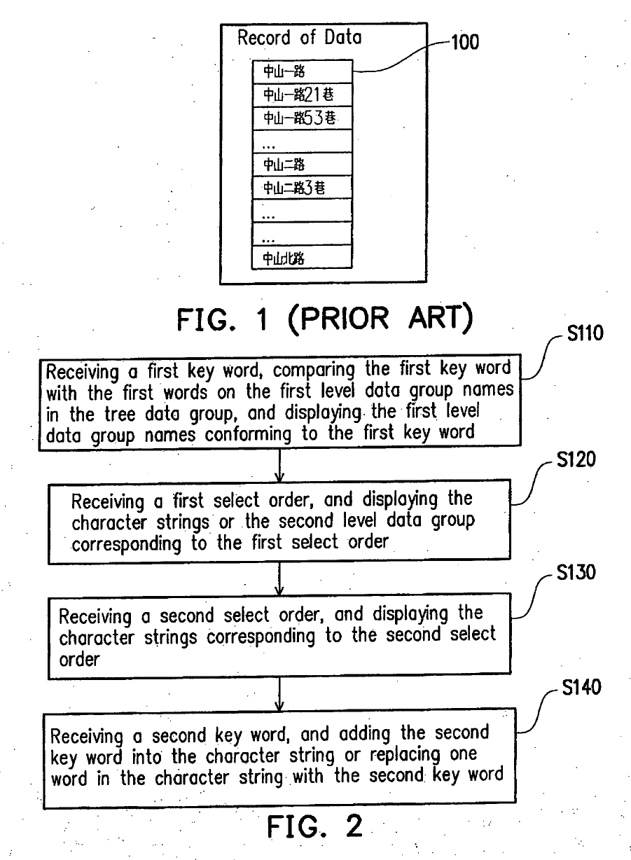

### DESCRIPTION PREFERRED EMBODIMENTS

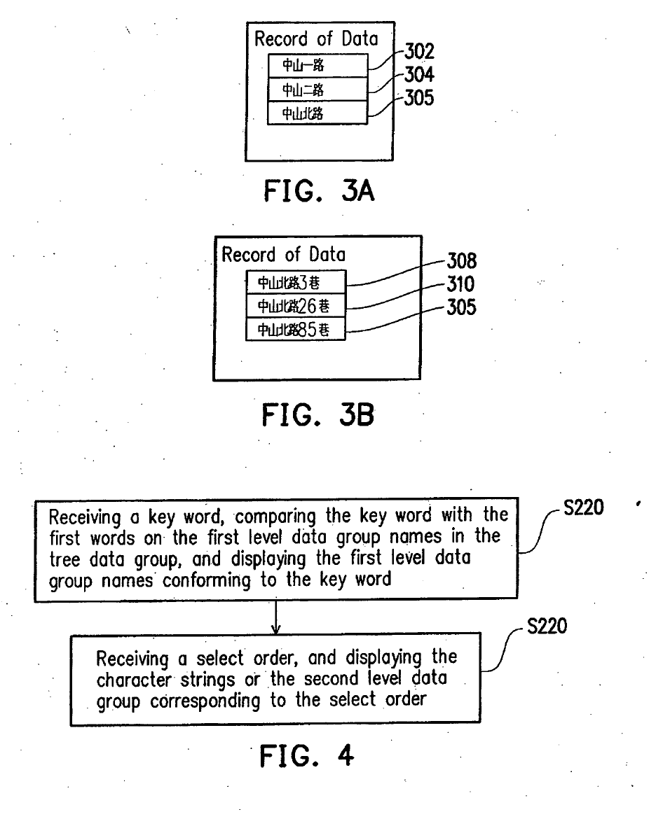

FIG. 2 schematically shows a flowchart illustrating a data processing method according to an embodiment of the present invention. FIGS. 3A and 3B schematically shows the screens while inputting the data. Referring to FIGS. 2, 3A and 3B, for an easy explanation, a case of inputting the address into the mobile phone is exemplified in the present embodiment. However, it is not the intention of the present invention to apply it only on the data process of inputting the address into the mobile phone, the present invention also can be applied on the data process such as inputting various data into the electronic dictionary or other types of electronic device.

The data processing method of the present embodiment is suitable for an electronic device (e.g. a mobile phone). Specifically, the address data stored in the electronic device is divided into multiple main data groups, such as the [symbol] [symbol] and [symbol] (as shown in FIG. 3A), wherein one part of the address data is the data group name. In the present invention, the main data group of the address data is organized mainly by the major streets. In addition, each main data group may have several records of address data (character string) or several sub data groups. For example, the [symbol] data group has a plurality of character string data such as the [symbol] [symbol] [symbol] [symbol] and [symbol] [symbol] If the [symbol] [symbol] is further divided into the [symbol] [symbol] and [symbol] [symbol] the [symbol] [symbol] herein is a sub data groups.

When the user desires to key in the address character string of [symbol] [symbol] into the mobile phone, the data processing method of the present embodiment comprises the following steps. First, in step S110, the mobile phone receives a first key word input by the user, such as a word [symbol] and the first word of the main data group name of the tree data groups is compared with the first key word, such that the main data group name conforming to the first key word (or the first level data group name) is displayed as shown in FIG. 3A. Then, in step S120, the mobile phone receives a first select order input by the user. For example, the main data group [symbol] is selected by the user, and the character string of the main data group or the sub data group (or the second level data group) corresponding to the first select order is displayed, such as the [symbol] [symbol] [symbol] [symbol] and [symbol] [symbol] shown in FIG. 3B.

Then, in step S130, the mobile phone receives a second select order input by the user. For example, the character string (or the sub data group) [symbol] [symbol] is selected by the user, and the character string corresponding to the second select order such as the [symbol] [symbol] is displayed. If the sub data group is selected, the third level data groups such as the [symbol] [symbol] and the [symbol] [symbol] are displayed. By repeatedly selecting all levels of the data groups as mentioned above, when the user selects a character string rather than a certain level data group (i.e. there is no further level data group), the process goes to step S140. In step S140, the mobile phone receives a second key word such as a word “1” input by the user, and the second key word is added into the character string for forming a character string [symbol] [symbol] Then, a word [symbol] is added into the original character string [symbol] [symbol] so as to form a new string [symbol] [symbol] Meanwhile, the flow of the data processing method provided by the present embodiment is roughly completed.

However, one word in the character string [symbol] [symbol] can be replaced with the second key word “1” mentioned above. For example, the word “3” in the character string [symbol] [symbol] is replaced with the second key word “1”, such that a new character string [symbol] [symbol] is formed. It is to be noted that although the first key word mentioned above is a Chinese character, it also can be a character, a number or a symbol of other types. Similarly, although the second key word mentioned above is a number, the second key word may be a character or a symbol.

In summary, the data is divided into different tree-like data groups in the present invention, and the certain level data group names conforming to the key word input by the user are displayed on the screen in different groups. Each time after the user's selection, the next level data group of the selected data group is displayed on the screen, and this process is repeated until the desired character string is selected. Certainly, the present invention also allows the user to directly input the data rather than just input the data by using the selection method.

Since the data (e.g. the address data) in the database is divided into different groups in the present invention, when the user desires to input the new address data, the user only has to input the key word, thus the electronic device can immediately compare the key word input by the user with the data in the database and display the data group conforming to the key word. In addition, the content of a data group is displayed on the screen only when the certain data group is selected by the user. Accordingly, comparing with the conventional technique, the present invention allows the user to easily select the data character string intended to be input. However, the present invention is not only used in the data input, but also suitable for the data query. The detail of the data query is described in greater detail hereinafter.

FIG. 4 schematically shows a flowchart illustrating a data processing method according to another embodiment of the present invention. Referring to FIGS. 4, 3A, and 3B, when the user desires to quickly query the data (e.g. the address) stored in the electronic device (e.g. the mobile phone) and the stored data have been divided into different groups with a tree structure, the data processing method of the present embodiment comprises the following steps. First, in step S210, the mobile phone receives a key word such as a word [symbol] input by the user, and the first word of the first level data group name is compared with the key word to display the first level data group name conforming to the key word (as shown in FIG. 3A). Then, in step S220, the mobile phone receives a select order input by the user. For example, the first level data group [symbol] is selected by the user, and the character string of the data group or the second level data group corresponding to the select order is displayed, such as the [symbol] [symbol] [symbol] [symbol] and [symbol] [symbol] shown in FIG. 3B.

Since the data stored in the electronic device (e.g. the mobile phone) have been divided into different groups with a tree structure in the present invention, the user can quickly query and obtain the desire data.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A data processing method for an electronic device, wherein tree-like data groups have been stored in the electronic device, and each first level data group in the tree data groups has a data group name, and each data group has a plurality of character strings, the data processing method comprises:
receiving a first key word, and comparing the first key word with the first words of the first level data group names of the tree data groups, so as to display the first level data group names conforming to the first key word; and
receiving a first select order, and displaying the character strings of the first level data group or the second level data groups corresponding to the first select order.

2. The data processing method of claim 1, wherein after displaying the character strings of the data group corresponding to the first select order, further comprises:
receiving a second select order, and displaying the character strings corresponding to the second select order; and
receiving a second key word, and adding the second key word into the character string.

3. The data processing method of claim 1, wherein after displaying the character strings of the data group corresponding to the first select order, further comprises:
receiving a second select order, and displaying the character strings corresponding to the second select order; and
receiving a second key word, and replacing one word in the character string with the second key word.

4. The data processing method of claim 1, wherein one of the tree data groups is an address tree data group.

5. The data processing method of claim 4, wherein one level of the address tree data group is street names.

6. The data processing method of claim 4, wherein one level of the address tree data group is lane names.

7. The data processing method of claim 4, wherein one level of the address tree data group is alley names.

8. The data processing method of claim 1, wherein the first key word comprises a character, a number or a symbol.

9. The data processing method of claim 1, wherein the second key word comprises a character, a number or a symbol.
